(19) United States
(12) Patent Application Publication
(10) Pub. No.: US 2024/0253443 A1
(43) Pub. Date: Aug. 1, 2024

(54) DRIVETRAIN AND VEHICLE

(71) Applicant: DEERE & COMPANY, MOLINE, IL (US)

(72) Inventors: MATTHIAS LANG, MANNHEIM (DE); DAVID MUELLER, DETTENHEIM (DE); RAINER GUGEL, PLANKSTADT (DE)

(21) Appl. No.: 18/416,456

(22) Filed: Jan. 18, 2024

(30) Foreign Application Priority Data
Feb. 1, 2023 (DE) 102023102489.2

(51) Int. Cl. B60K 1/04; B60K 1/00; B60K 17/12; B60K 17/28; B60K 17/356

(52) U.S. Cl. CPC B60K 1/04; B60K 17/12; B60K 17/28; B60K 17/356; B60K 2001/001

(57) ABSTRACT

A drivetrain for a vehicle includes a first electric machine, an input shaft connected to the first electric machine, an output shaft, an energy store connected to the first electric machine, and a magnetic-electrical epicyclic transmission stage having a rotor connected to the input shaft, a stator, and an interposed modulation ring connected to the output shaft. The energy store is connected to the stator such that electrical power can be transmitted from the energy store to the stator, which is operable such that the output shaft is rotatable counter to the direction of rotation of the input shaft, such that the drivetrain can be operated in a forward and a reverse traction mode.

### CROSS-REFERENCE TO RELATED APPLICATIONS

This application claims priority to German patent application Ser. No. 102023102489.2, filed Feb. 1, 2023, which is hereby incorporated by reference.

### FIELD OF THE DISCLOSURE

The disclosure relates to a drivetrain for a vehicle.

### BACKGROUND

A transmission system usually includes an input shaft, a shiftable transmission, and an output shaft. Transmission systems change the input drive power in terms of torque and speed and provide this to the output. A transmission system can use manual transmissions or continuously variable transmissions as components.

### SUMMARY

EP 3 945 665 A1 discloses a transmission system for an agricultural machine. The disclosed transmission system is suitable for operation using an internal combustion engine or a hydraulic motor, and comprises a power-split transmission portion which has at least one variable transmission branch and one mechanical transmission branch. The variable branch has, at an input side and at an output side, in each case at least one electric machine for generator and motor operation. The electric machines are electrically connected to one another. The drive power is divided up by and conducted through the mechanical and the variable branch. A magnetic-electrical epicyclic transmission stage coupled at an input side merges the variable and mechanical branches. A potential disadvantage of the transmission system in EP 3 945 665 A1 is that it may require an internal combustion engine. Furthermore, the transmission system could potentially be considered a complex structural design.

The present disclosure is therefore based on the object of proposing a drivetrain and a vehicle by means of which the aforementioned potential disadvantages are overcome. For example, it is sought to propose a drivetrain and a vehicle which are of simpler and/or less complex structural design and/or are operable using only electric machines and/or for example are operable in a forward and a reverse traction mode.

This object is achieved by a drivetrain having the features of one or more of the following embodiments. Advantageous embodiments of the disclosure are included below.

According to the disclosure, a drivetrain for a vehicle, for example an agricultural vehicle or an agricultural towing vehicle or a construction machine, such as a tractor, is proposed. The drivetrain comprises a first electric machine and an input shaft, wherein the input shaft is connected to and/or driveable by, for example driveably connected and/or mechanically coupled or mechanically couplable to, the first electric machine. The drivetrain comprises an energy store which is connected and/or couplable, for example electrically connected and/or electrically couplable, to the first electric machine. The drivetrain furthermore comprises an output shaft and a magnetic-electrical epicyclic transmission stage which comprises a rotor, for example an internal rotor, a stator, for example an external stator, and an interposed modulation ring, for example a magnetic modulation ring. The modulation ring, which may for example comprise or be a drive output of the epicyclic transmission stage, is connected, for example driveably connected and/or mechanically coupled or mechanically couplable, to the output shaft. The internal rotor is connected, for example driveably connected and/or mechanically coupled or mechanically couplable, to the input shaft. The energy store is connected and/or couplable, for example electrically connected and/or electrically couplable, to the stator, such that electrical power can be transmitted from the energy store to the stator of the epicyclic transmission stage. The magnetic-electrical epicyclic transmission stage, for example the stator, is operable, in some embodiments actuatable and/or controllable in open-loop and/or closed-loop fashion, in some embodiments settable and/or adjustable, such that the output shaft is rotatable counter to the direction of rotation of the input shaft, such that the drivetrain is operable, in some embodiments actuatable and/or controllable in open-loop and/or closed-loop fashion, in some embodiments settable and/or adjustable, in a forward and a reverse traction mode. The direction of rotation of the output shaft can thus be counter or opposite to the direction of rotation of the input shaft.

In other words, the magnetic-electrical epicyclic transmission stage, for example the stator, can be actuatable to implement a direction of rotation of the output shaft that is opposite to the direction of rotation of the input shaft. Here, the reverse traction mode of the drivetrain can be made possible by virtue of the rotational speed of the first electric machine being superposable in the magnetic-electrical epicyclic transmission stage such that the direction of rotation of the modulation ring or of the drive output of the magnetic-electrical epicyclic transmission stage, and for example also of the output shaft, is operable, in some embodiments actuatable and/or controllable in open-loop and/or closed-loop fashion, in some embodiments settable and/or adjustable, oppositely to the direction of rotation of the input shaft or to the forward traction mode.

The drivetrain thus varies the drive power, which is introduced by means of the first electric machine and/or the stator and/or a second electric machine, in terms of torque and rotational speed. The energy store may be a battery and/or a supercapacitor and/or a fuel cell and/or some other device for storing electrical energy. The first and/or second electric machine may be an electric motor and/or a fuel cell, for example a permanent-magnet and/or electrically excited synchronous and/or asynchronous machine that is operated using direct current and/or three-phase current, in some embodiments a permanent-magnet three-phase synchronous machine.

The internal rotor may comprise a first number of magnetic pole pairs. The internal rotor may be connected, for example driveably connected and/or mechanically coupled or couplable, to the first electric machine via the input shaft. The external stator may be an external rotor that comprises a second number of magnetic pole pairs. Likewise, the external stator may be formed a stator having coils, for example as the second electric machine. If alternating current is applied to the coils, a rotating electromagnetic field is generated as a result. The electromagnetic field is functionally equivalent to the external rotor with permanent magnets. The first electric machine and the stator, for example the second electric machine, may be operable, in some embodiments actuatable and/or controllable in open-loop and/or closed-loop fashion, in some embodiments settable and/or adjustable, in a generator and/or motor mode. The electrical power of the first electric machine may be greater than the electrical power of the external stator or of the second electric machine. The modulation ring may comprise a third number of ferromagnetic segments, such that the electromagnetic field modulates between rotor and stator.

For example, the drivetrain may comprise a transmission device. The transmission device may have a mechanical transmission branch and a variable transmission branch. Furthermore, the transmission device, for example the variable transmission branch, may comprise the magnetic-electrical epicyclic transmission stage. The variable transmission branch may be connected at an input side to the energy store and thus for example also to the first electric machine. The variable transmission branch may be connected at an output side to the stator, for example to the second electric machine. The drive power can be divided up by and conducted through the mechanical and the variable transmission branch. The magnetic-electrical epicyclic transmission stage may be coupled at an input side. Furthermore, the magnetic-electrical epicyclic transmission stage may merge the variable transmission branch and mechanical transmission branch. The stator, for example the second electric machine, may thus be operatively connected to the modulation ring of the magnetic-electrical epicyclic transmission stage, which in turn interacts with the rotor. The energy store and the stator or the second electric machine, together with the magnetic-electrical epicyclic transmission stage, constitute the variable transmission branch, and together with the input shaft, constitute the transmission device. The mechanical transmission branch may be formed of the input shaft. The magnetic-electrical epicyclic transmission stage may be actuatable by means of the stator, and for example, the second electric machine, or the stator itself, for example the second electric machine itself, may be actuatable, such that the output shaft of the magnetic-electrical epicyclic transmission stage can be rotatable in the opposite direction to the input shaft. An additional reverse gear can be omitted, and the overall structure of the drivetrain is simplified in terms of design, whereby the required number of parts and corresponding production and installation operations are reduced. Furthermore, the drivetrain can advantageously be operated fully electrically.

In one refinement of the disclosure, the drivetrain comprises a control unit. The drivetrain, for example the first electric machine and/or the energy store and/or the magnetic-electrical epicyclic transmission stage, in some embodiments the stator, in some embodiments the second electric machine, and/or a set of power electronics and/or a first transmission unit and/or a second transmission unit and/or a powershift reversing unit and/or one or more actuators of the drivetrain, may be operable, in some embodiments actuatable and/or controllable in open-loop and/or closed-loop fashion, in some embodiments settable and/or adjustable, via or by means of the control unit. For example, the magnetic-electrical epicyclic transmission stage, for example the stator, may be operable, in some embodiments actuatable and/or controllable in open-loop and/or closed-loop fashion, in some embodiments settable and/or adjustable, via or by means of the control unit such that the output shaft is rotatable counter to the direction of rotation of the input shaft, such that the drivetrain is operable in a forward and a reverse traction mode.

The control unit may be assigned to the drivetrain, or the drivetrain may comprise the control unit. The control unit may be configured as an electronic module, as an embedded system, as a processing unit, as a computer, or as a module for the open-loop and/or closed-loop control of the device. The control unit may comprise a processor, a memory and/or all of the software, hardware, algorithms, connectors, and for example also sensors, that are required for the open-loop and/or closed-loop control of the drivetrain. A method may be configured as a program or algorithm that can be executed on and/or by means of the control unit. The control unit may comprise any device that can analyze data from various sensors, compare data, and make the decisions necessary to control, in open-loop and/or closed-loop fashion, and/or perform, the operation of the drivetrain and the required tasks for the open-loop and/or closed-loop control of the operation of the drivetrain.

The control unit may be connected, in some embodiments have a signal connection and/or signal-transmitting connection and/or data-transmitting connection, to the drivetrain, for example to the first electric machine and/or to the energy store and/or to the magnetic-electrical epicyclic transmission stage, in some embodiments to the stator, in some embodiments to the second electric machine, and/or to the set of power electronics and/or to the first transmission unit and/or to the second transmission unit and/or to the powershift reversing unit and/or to one or more actuators of the drivetrain. The control unit may be configured for operating, in some embodiments controlling, in open-loop and/or closed-loop fashion, and/or actuating, in some embodiments setting and/or adjusting, the first electric machine and/or the energy store and/or the magnetic-electrical epicyclic transmission stage and/or the stator or the second electric machine and/or the set of power electronics. A signal connection and/or signal-transmitting and/or data-transmitting connection may be understood here inter alia to mean that signals or data are exchanged between the connected components. Signals may for example be received and transmitted, and/or processed and/or manipulated, by the control unit. The connection between the control unit and the components of the drivetrain may be wired, for example implemented by wire, and/or may be wireless, for example implemented by radio, for example by Bluetooth or WLAN. The communications bus may for example be Isobus, CAN bus, or similar. Moreover, a further control unit may be controllable in open-loop and/or closed-loop fashion, and/or actuatable, via or by means of the control unit. The further control unit may be configured similarly to the control unit. The control unit may be assigned to the vehicle, for example arranged on the vehicle. The control device may also be configured in two parts, for example as part of the vehicle and as part of the drivetrain. The control unit may be connected directly to the input and output unit which is arranged in a cab of the vehicle and by means of which data entered by an operator can be transmitted to the control unit or received from the control unit and output. It is however also conceivable for the control unit to be connected indirectly to the input and output unit by a superordinate control unit. The control unit may be integrated into the input and output unit or vice versa.

In one refinement of the disclosure, the drivetrain comprises a set of power electronics to transmit the electrical power between the first electric machine, the energy store, and the stator of the magnetic-electrical epicyclic transmission stage. The energy store and the first electric machine and the stator or the second electric machine may be connected to one another, for example by wire, such that electrical power can be transmitted between them. Electrical power may be transmissible by means of the first electric machine to the energy store or vice versa. Likewise, electrical power may be transmissible from the energy store to the stator or vice versa. The first electric machine, the energy store, and the stator, for example the second electric machine, may be actuatable, for example settable and/or adjustable, by means of the set of power electronics. The set of power electronics may likewise communicate with the control unit. The set of power electronics may comprise an electronic control device and/or an inverter and/or a voltage transformer. During operation, the inverter may transform the voltage of the energy store into a voltage that is required by the first electric machine and/or the stator or the second electric machine. This operation may be reversed for the purposes of charging the energy store. The voltage transformer may however also convert the energy of the energy store into a voltage that is required for the on-board electrical system of the vehicle. Resulting advantages include the fact that a second energy store for operating the on-board electrical system can optionally be omitted, devices operated using the voltage of the on-board electrical system (for example an absorption refrigerator connected to the 12 V socket) can be operated for longer, and a discharged energy store for providing a supply to the on-board electrical system can be recharged by means of the energy stores for the traction drives.

In one refinement of the disclosure, the output shaft is a hollow shaft, and/or the input shaft is a solid shaft, and/or the input shaft is arranged in the output shaft, and/or the output shaft is coaxial with respect to the input shaft. An optimum spatial arrangement of the two shafts in the drivetrain or vehicle can thus advantageously be realized.

In one refinement of the disclosure, the first electric machine is connected, for example driveably connected and/or mechanically coupled or mechanically couplable, via or by means of the input shaft to a power take-off, and the modulation ring, or for example the drive output of the epicyclic transmission stage, is connected, for example driveably connected and/or mechanically coupled or mechanically couplable, via or by means of the output shaft to a drive. It is thus possible for drive power, for example a torque and/or a rotational speed, to be transmitted from the first electric machine to the power take-off. Furthermore, drive power or traction power can be transmitted from the modulation ring to a drive, such that the drivetrain or the vehicle can be driven. For example, drive power or traction power can be transmitted from the first electric machine to the magnetic-electrical epicyclic transmission, and from the modulation ring to the drive. The drive may for example comprise a first vehicle axle and/or a second vehicle axle and/or a first differential and/or a second differential and/or the one or more ground-engaging means. This embodiment of the drivetrain is advantageously of structurally simpler and less complex design. Furthermore, it is thus advantageously possible for the drivetrain and the vehicle to be operable using only electric machines, such that an environmentally friendly drivetrain based only on electrical energy can be realized.

A reversed configuration is however advantageously also possible, for example the first electric machine is connected, for example driveably connected and/or mechanically coupled or mechanically couplable, via or by means of the input shaft to the drive, and the modulation ring is connected, for example driveably connected and/or mechanically coupled or mechanically couplable, via or by means of the output shaft to the power take-off. In this way, drive power or traction power can be transmitted from the first electric machine to a drive, such that the drivetrain or the vehicle can be driven. Furthermore, drive power can be transmitted from the modulation ring to the power take-off. For example, drive power can be transmitted from the first electric machine to the magnetic-electrical epicyclic transmission, and from the modulation ring to the power take-off. This embodiment of the drivetrain is advantageously of structurally simpler and less complex design. Furthermore, it is thus advantageously possible for the drivetrain and the vehicle to be operable using only electric machines, such that an environmentally friendly drivetrain based only on electrical energy can be realized.

In one refinement of the disclosure, the drivetrain comprises a first and/or second transmission unit. The first and/or second transmission unit may be positioned upstream or downstream, in some embodiments downstream, of the magnetic-electrical epicyclic transmission stage, for example the transmission device, in the power flow. The first and/or second transmission unit may have a reverse gear. The first transmission unit may be a stepped transmission, for example a single-ratio transmission or a multi-ratio transmission, or a dual-clutch transmission, or a continuously variable transmission. The second transmission unit may be a power take-off transmission, for example in the form of a two-ratio or four-ratio spur-gear transmission. The stepped transmission may comprise clutches, for example powershift clutches, and one or more identical or different gear stages. The clutches may interconnect the meshing gear stages. The multi-ratio transmission may be shiftable, for example fully powershiftable, into multiple powershift ratio stages. The continuously variable transmission may comprise one or more hydraulic variators to be able to reliably convert relatively high levels of drive power. Here, at an input side of the continuously variable transmission, a proportion of the drive power is converted into hydraulic power by means of hydrostatic arrangements. The proportion of the hydraulic power can be varied by means of the variators. At an output side, the hydraulic energy is converted back into mechanical energy. It is advantageously thus possible for additional gears or gear ratios to be implemented by means of the drivetrain, and at the same time the structural space of the drivetrain can be reduced or kept small.

In one refinement of the disclosure, the drivetrain comprises a powershift reversing unit for reversing the direction of travel, for example a powershift-capable or non-powershift-capable powershift reversing unit. The powershift reversing unit may be positioned upstream or downstream of the magnetic-electrical epicyclic transmission stage in the power flow. The powershift reversing unit may be a transmission stage for reversing a direction of rotation. The powershift reversing unit may be arranged between the first electric machine and the magnetic-electrical epicyclic transmission stage in the power flow, or may be arranged downstream of the magnetic-electrical epicyclic transmission stage, for example at and/or on the output shaft. The powershift reversing unit may be designed as an individual component of the drivetrain. Complexity is thus reduced. The powershift reversing unit may be designed for a relatively low torque, whereby expenditure on production and component weight can be reduced.

As a further advantageous measure, the powershift reversing unit has a planetary gear set. Furthermore, a clutch device may be positioned upstream of the powershift reversing unit, for example the planetary gear set. The powershift reversing unit can be decoupled from the drivetrain by means of the clutch device.

In one refinement of the disclosure, a rear-axle bevel gear drive is connected to the output shaft, and/or the output shaft is connected, for example driveably connected and/or mechanically coupled or mechanically couplable, to a toothing of a front-axle drive. Advantageously, on account of the direct connection of the output shaft to the rear-axle bevel gear drive, it is possible to dispense with expensive connecting elements, for example an articulated shaft, that tend to need maintenance. Moreover, the output shaft is connected to a toothing of a front-axle drive. To that end, a front-axle drive gear may be connected to the output shaft, for example rotationally conjointly connected to the output shaft, or selectively rotationally conjointly connectable thereto and releasable therefrom. However, the front-axle drive gear may also be arranged independently of the output shaft, for example formed as part of the front-axle drive. In this respect, the front-axle drive gear may mesh with a toothed gear on the output shaft, for example a front-axle gear. The front-axle gear may be connected, for example rotationally conjointly connected, to the output shaft, or selectively rotationally conjointly connectable thereto or releasable therefrom. It is advantageously thus possible for the front-axle drive to be connected, for example driveably connected and/or mechanically coupled or mechanically couplable, to the rear-axle bevel gear drive by means of the output shaft. Moreover, the output shaft advantageously additionally takes on the function of connecting a first and a second vehicle axle, as a result of which it is possible to dispense with a further connecting element.

The disclosure furthermore relates to a vehicle, for example an agricultural vehicle or an agricultural towing vehicle or a construction machine, such as a tractor, having a drivetrain. The vehicle may comprise the first electric machine and/or the stator or the second electric machine as a drive motor. Here, the vehicle may be driveable by means of the drivetrain, for example may be driveable by the first electric machine and/or the stator or the second electric machine. The drivetrain may be driveably connected to at least one vehicle axle of the vehicle, for example to the second vehicle axle or the rear axle, and/or may be connected or connectable, so as to be capable of outputting drive, to a further vehicle axle of the vehicle, for example to the first vehicle axle or the front axle. The vehicle according to the disclosure has the above-described advantages of the drivetrain according to the disclosure.

The drivetrain and the vehicle may be operable as follows. The first electric machine can generate drive power using the electrical energy or power from the energy store, and can transmit the drive power as mechanical power to the input shaft. At the same time, electrical energy or power can be transmitted from the energy store to the stator, for example the second electric machine. The open-loop and/or closed-loop control and/or actuation the supply and exchange of electrical energy, for example current and voltage, between energy store and first electric machine and stator or second electric machine may be performed by means of the set of control electronics and/or the control unit. With the open-loop and/or closed-loop control and/or actuation of the electrical energy or of current and voltage, it is possible for the power, for example rotational speed and/or torque, which is generated at the magnetic-electrical epicyclic transmission stage, and which is output, to be controlled in open-loop and/or closed-loop fashion and/or actuated, for example set and/or adjusted. By varying the excitation frequency, different torques and/or rotational speeds can be set in the magnetic-electrical epicyclic transmission stage. The power applied to the rotor and the power applied to the stator determine the power prevailing at the modulation ring. The power, for example rotational speed and/or torque, which is output owing to the interaction at the magnetic-electrical epicyclic transmission, for example between stator, modulation ring and rotor, can be transmitted by means of the modulation ring to the output shaft and, depending on the example embodiment, from the output shaft to the first or transmission unit and/or the power take-off and/or the drive. The remaining proportion of mechanical power at the input shaft may depending on the example embodiment, be transmitted to the first or transmission unit and/or the power take-off and/or the drive.

The above and other features will become apparent from the following detailed description and accompanying drawings.

### BRIEF DESCRIPTION OF THE DRAWINGS

The disclosure and further advantages and advantageous developments and refinements of the disclosure, in terms of the hardware and the method, will be explained in more detail below by means of example embodiments and with reference to the drawing. Components of comparable or corresponding function are identified here by the same reference signs. In the drawings:

FIG. 1 shows a schematic illustration of a vehicle according to the disclosure;

FIG. 2 shows a schematic illustration of a first example embodiment of the drivetrain according to the disclosure;

FIG. 3 shows a schematic illustration of a second example embodiment of the drivetrain according to the disclosure;

FIG. 4 shows a schematic illustration of a third example embodiment of the drivetrain according to the disclosure;

FIG. 5 shows a schematic illustration of a fourth example embodiment of the drivetrain according to the disclosure;

FIG. 6 shows a schematic illustration of a fifth example embodiment of the drivetrain according to the disclosure;

FIG. 7 shows a schematic illustration of a sixth example embodiment of the drivetrain according to the disclosure; and

FIG. 8 shows a schematic illustration of a seventh example embodiment of the drivetrain according to the disclosure.

### DETAILED DESCRIPTION

The embodiments or implementations disclosed in the above drawings and the following detailed description are not intended to be exhaustive or to limit the present disclosure to these embodiments or implementations.

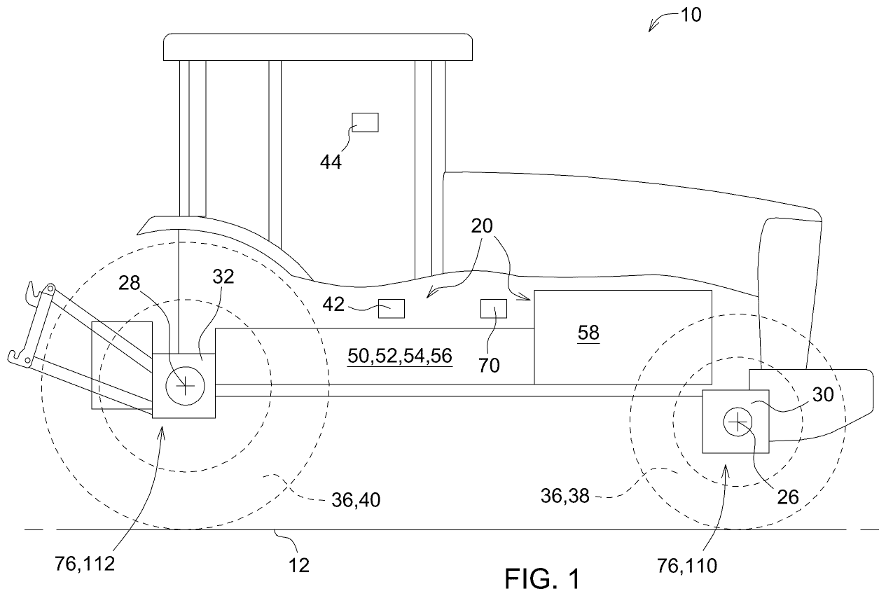

FIG. 1 shows a schematic illustration of a first example embodiment of a vehicle 10 according to the disclosure, in this case a tractor, having a drivetrain 20 according to the disclosure. The vehicle 10 can be driven by means of the drivetrain 20.

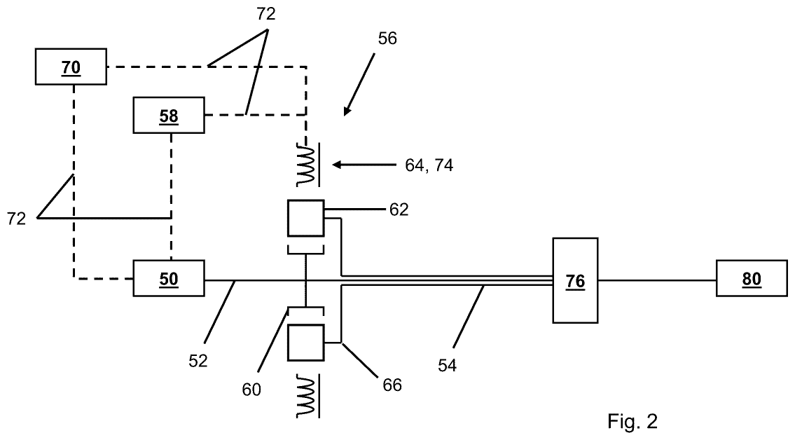

The drivetrain 20 comprises a first electric machine 50, an input shaft 52 (see also FIGS. 2 to 8), which is connected, for example driveably connected and/or mechanically coupled or mechanically couplable, to the first electric machine 50, and an output shaft 54 (see FIGS. 2 to 8), an energy store 58, which is connected and/or couplable to the first electric machine 50, and a magnetic-electrical epicyclic transmission stage 56.

The vehicle 10, for example the drivetrain 20, comprises a first vehicle axle 26 and a second vehicle axle 28. The first vehicle axle 26 may be a front axle, and the second vehicle axle 28 may be a rear axle. Moreover, the first vehicle axle 26 may be embodied as a steerable axle. The vehicle 10, for example the drivetrain 20, may furthermore comprise a first differential 30, for example a front axle differential. The first vehicle axle 26 may be connected, for example driveably connected and/or mechanically couplable or mechanically coupled, to the first differential 30. The vehicle 10, for example the drivetrain 20, may furthermore comprise a second differential 32, for example a rear axle differential. The second vehicle axle 28 may be connected, for example driveably connected and/or mechanically couplable or mechanically coupled, to the second differential 32. The first differential 30 and the second differential 32 may be provided optionally.

The first electric machine 50 may be designed for example as an electric motor or fuel cell. A rotational movement and/or force and/or a torque may be capable of being generated, and transmitted to the first and/or second vehicle axle 26, 28, by means of the first electric machine 50. The first and/or second vehicle axle 26, 28 convert(s) the rotational movement and/or force and/or the torque of the first electric machine 22 into a rotational movement and/or force and/or a torque of one or more ground-engaging means 36, and thus into propulsion of the vehicle 10. The vehicle 10 may have one or more ground-engaging means 36, in this case in the form of wheels 38, 40, which engage with an underlying surface 12 in order to transmit drive forces and/or by way of which the vehicle 10 is supported on the underlying surface 12. The vehicle 10 may also have a chassis (not illustrated), wherein the chassis may for example be supported by the wheels 38, 40 that are suspended on the first and/or the second vehicle axle 28, 30. For example, a first pair of wheels 38 is arranged on the first vehicle axle 26, and a second pair of wheels 40 is arranged on the second vehicle axle 28. Here, the diameters of the wheels 38, 40 may differ; for example, the diameter of the first pair of wheels 38 may be smaller than the diameter of the second pair of wheels 40. Alternatively, the ground-engaging means 36 may also be configured and arranged as tracks or chains.

The vehicle 10, and for example the drivetrain 20, may comprise a control unit 42. The control unit 42 may be connected directly to an input and output unit 44 which is arranged in a cab of the vehicle and by means of which data entered by an operator can be transmitted to the control device 42 or received from the control device and output. The drivetrain 20 may be operable via or by means of the control unit 42.

Furthermore, the vehicle 10, for example the drivetrain 20, may comprise a set of power electronics 70 in order to transmit the electrical power or energy between the first electric machine 50, the energy store 58 and a stator 62 (see FIGS. 2 to 8) of the magnetic-electrical epicyclic transmission stage 56.

The vehicle 10, for example the drivetrain 20, comprises a drive 76. The drive 76 may comprise the first vehicle axle 26 and/or the second vehicle axle 28 and/or the first differential 30 and/or the second differential 32 and/or the one or more ground-engaging means 36. The vehicle 10, for example the drivetrain 20, may have a front-axle drive 110, which may comprise the first vehicle axle 26 and/or the first differential 30 and/or the one or more ground-engaging means 36. Likewise, the vehicle 10, or for example the drivetrain 20, may have a rear-axle drive 102, which may comprise the second vehicle axle 28 and/or the second differential 32 and/or the one or more ground-engaging means 36.

FIG. 2 shows a schematic illustration of the first example embodiment of the drivetrain 20 according to the disclosure. The drivetrain 20 shown in FIG. 2 corresponds substantially to the drivetrain 20 shown in FIG. 1, and therefore only details and/or points of differentiation will be discussed below. The vehicle 10 may comprise the drivetrain 20 as illustrated in FIG. 2.

The magnetic-electrical epicyclic transmission stage 56 comprises a rotor 60, a stator 64 and an interposed magnetic modulation ring 62. The modulation ring 62 is connected to the output shaft 54. The rotor 60 is connected, for example driveably connected and/or mechanically coupled or mechanically couplable, to the input shaft 52. The energy store 58 is connected and/or couplable, for example electrically connected and/or electrically couplable, to the first electric machine and the stator 64, for example a second electric machine 74, such that electrical power can be transmitted between the components, for example from and to the energy store 58. The magnetic-electrical epicyclic transmission stage 56, for example the stator 64, is operable such that the output shaft 54 is rotatable counter to the direction of rotation of the input shaft 52, such that the drivetrain 20 can be operated in a forward and a reverse traction mode.

In other words, the magnetic-electrical epicyclic transmission stage 56, for example the stator 64, can be actuatable in order to implement a direction of rotation of the output shaft 54 that is opposite to the direction of rotation of the input shaft 52. For example, the magnetic-electrical epicyclic transmission stage 56, for example the stator 64, may be operable, in some embodiments actuatable and/or controllable in open-loop and/or closed-loop fashion, in some embodiments settable and/or adjustable, by means of the control unit 42 such that the output shaft 54 is rotatable counter to the direction of rotation of the input shaft 52, such that the drivetrain 20 is operable in a forward and a reverse traction mode. Here, the reverse traction mode of the drivetrain 20 can be made possible by virtue of the rotational speed of the first electric machine 50 being superposed in the magnetic-electrical epicyclic transmission stage 56 such that the direction of rotation of the modulation ring 62 or of the drive output of the magnetic-electrical epicyclic transmission stage 66, and thus also of the output shaft 54, is operable, in some embodiments actuatable and/or controllable in open-loop and/or closed-loop fashion, in some embodiments settable and/or adjustable, oppositely to the direction of rotation of the input shaft 52 or in the forward traction mode.

By means of the set of power electronics 70, in order to transmit electrical power between the first electric machine 50, the energy store 58 and the stator 64 of the magnetic-electrical epicyclic transmission stage 56. The energy store 58 and the first electric machine 50 and the stator 64, for example the second electric machine 74, may be connected by means of connecting elements, in the present case by wire 72, such that electrical power can be transmitted between them. Electrical power may be transmissible by means of the first electric machine 50 to the energy store 58 and vice versa. Likewise, electrical power may be transmissible from the first energy store 58 to the stator 64, or the second electric machine, and vice versa. The set of power electronics 70 may comprise an electronic control device and/or an inverter and/or a voltage transformer.

The output shaft 54 is configured as a hollow shaft, and the input shaft 52 is configured as a solid shaft. The input shaft 52 is arranged in the output shaft 54. The output shaft 54 is arranged coaxially with respect to the input shaft 52. It is however also possible for the output shaft 54 to be configured as a solid shaft and for the input shaft 52 to be configured as a hollow shaft. Then, the input shaft 52 would be arranged in the output shaft 54.

The first electric machine 50 is connected, for example driveably connected and/or mechanically coupled or mechanically couplable, via or by means of the input shaft 52 to a power take-off 80. The modulation ring 60 is connected, for example driveably connected and/or mechanically coupled or mechanically couplable, via or by means of the output shaft 54 to the drive 76. It is thus possible for drive power, for example a torque and/or a rotational speed, to be transmitted from the first electric machine 50 to the power take-off 80. Furthermore, drive power or traction power can be transmitted from the modulation ring 60 to the drive 76, such that the drivetrain 20 or the vehicle 10 can be driven. For example, drive power or traction power can be transmitted from the first electric machine 50 to the magnetic-electrical epicyclic transmission 56, and from the modulation ring 60 to the drive 76.

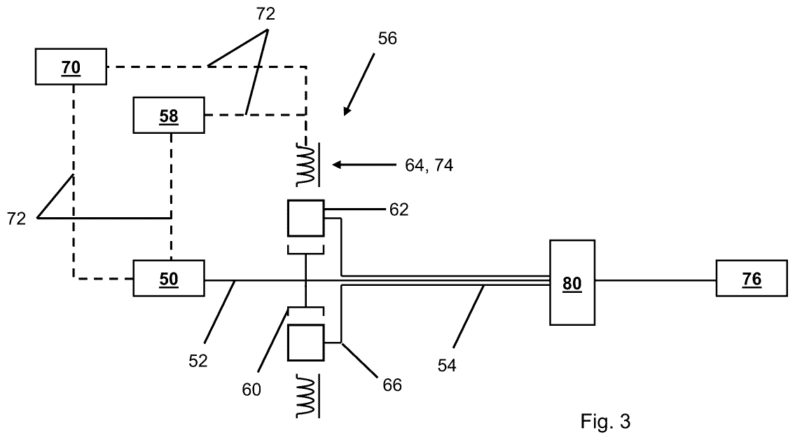

FIG. 3 shows a schematic illustration of the second example embodiment of the drivetrain 20 according to the disclosure. The drivetrain 20 shown in FIG. 3 corresponds substantially to the drivetrain 20 shown in FIGS. 1 and 2, and therefore only details and/or points of differentiation will be discussed below. The vehicle 10 may comprise the drivetrain 20 as illustrated in FIG. 3. In the drivetrain 20 according to FIG. 3, the first electric machine 50 is connected, for example driveably connected and/or mechanically coupled or mechanically couplable, via the input shaft 52 to the drive 76, and the modulation ring 62 is connected, for example driveably connected and/or mechanically coupled or mechanically couplable, via the output shaft 54 to the power take-off 80.

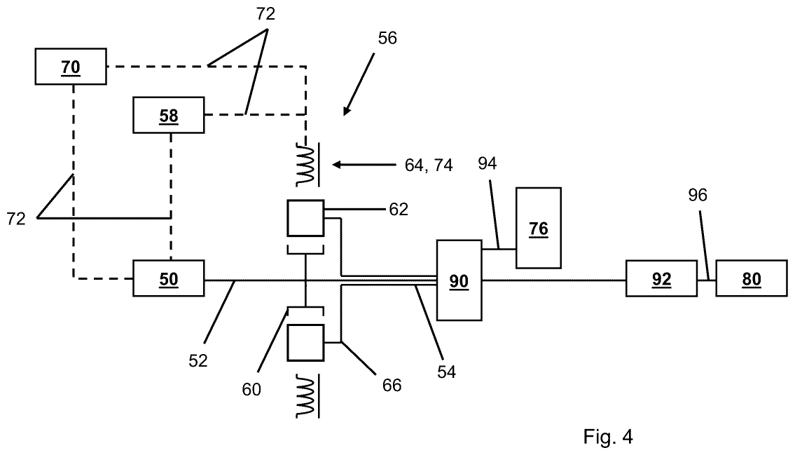

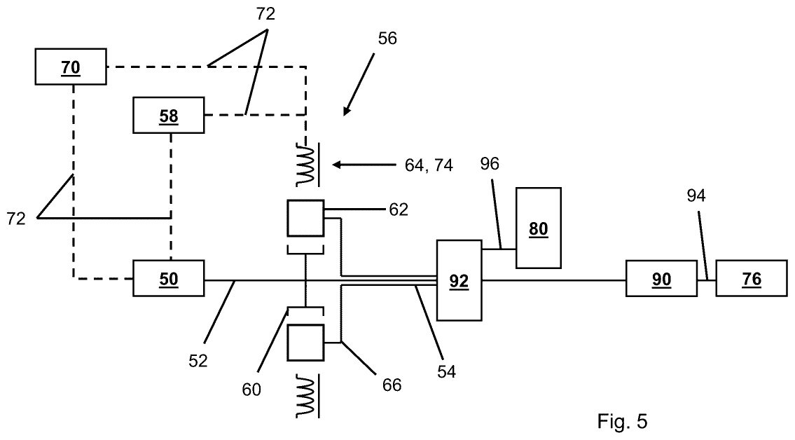

FIGS. 4 and 5 show schematic illustrations of a third and a fourth example embodiment of the drivetrain 20 according to the disclosure. The drivetrain 20 shown in FIG. 4 corresponds substantially to the drivetrains 20 shown in FIGS. 1 to 3, and the drivetrain 20 shown in FIG. 5 corresponds substantially to the drivetrains 20 shown in FIGS. 1 to 4, and therefore only details and/or points of differentiation will be discussed below. The vehicle 10 may comprise the drivetrains 20 as illustrated in FIGS. 4 and 5.

The drivetrains according to FIGS. 4 and 5 comprise a first and/or a second transmission unit 90, 92. The drivetrain 20 may thus comprise either the first or the second transmission unit 90, 92 or both transmission units or no transmission unit. The first and/or second transmission unit 90, 92 may be positioned upstream or downstream of the magnetic-electrical epicyclic transmission stage 56 in the power flow. In the present case, the first and second transmission units 90, 92 are positioned downstream of the magnetic-electrical epicyclic transmission stage 56 in the power flow. The first and/or second transmission unit 90, 92 may have a reverse gear. The first transmission unit 90 may be a stepped transmission, for example a single-ratio transmission or a multi-ratio transmission, or a dual-clutch transmission, or a continuously variable transmission. The second transmission unit 92 may be a power take-off transmission.

FIG. 4 shows a drivetrain 20 in which the first electric machine 50 is connected, for example driveably connected and/or mechanically coupled or mechanically couplable, via the input shaft 52 to the second transmission unit 92. Here, the output of the second transmission unit 96 is connected, for example driveably connected and/or mechanically coupled or mechanically couplable, to the power take-off 80. The modulation ring 62 or the drive output of the epicyclic transmission stage 66 is connected, for example driveably connected and/or mechanically coupled or mechanically couplable, via the output shaft 54 to the first transmission unit 90. The output of the first transmission unit 94 is in this case connected, for example driveably connected and/or mechanically coupled or mechanically couplable, to the drive 76.

FIG. 5 shows a drivetrain 20 with a reversed arrangement. The first electric machine 50 is connected, for example driveably connected and/or mechanically coupled or couplable, via the input shaft 52 to the first transmission unit 90. The output of the first transmission unit 94 is in this case connected, for example driveably connected and/or mechanically coupled or mechanically couplable, to the drive 76. The modulation ring 62 or the drive output of the epicyclic transmission stage 66 is connected, for example driveably connected and/or mechanically coupled or mechanically couplable, via the output shaft 54 to the second transmission unit 92. The output of the second transmission unit 96 is connected, for example driveably connected and/or mechanically coupled or mechanically couplable, to the power take-off 80.

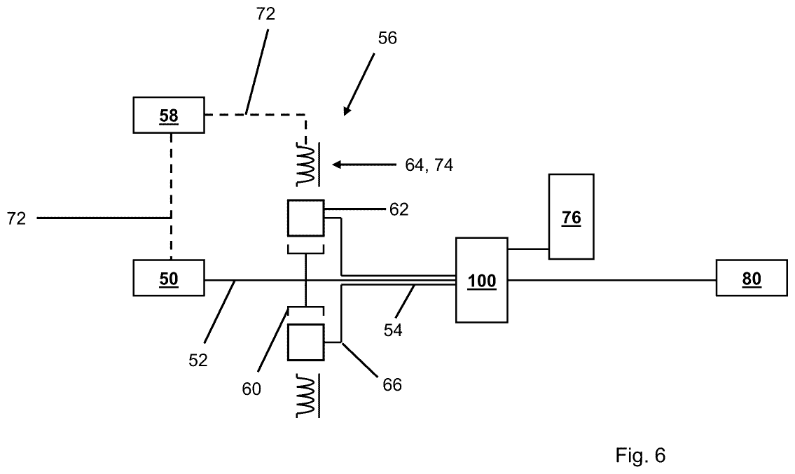

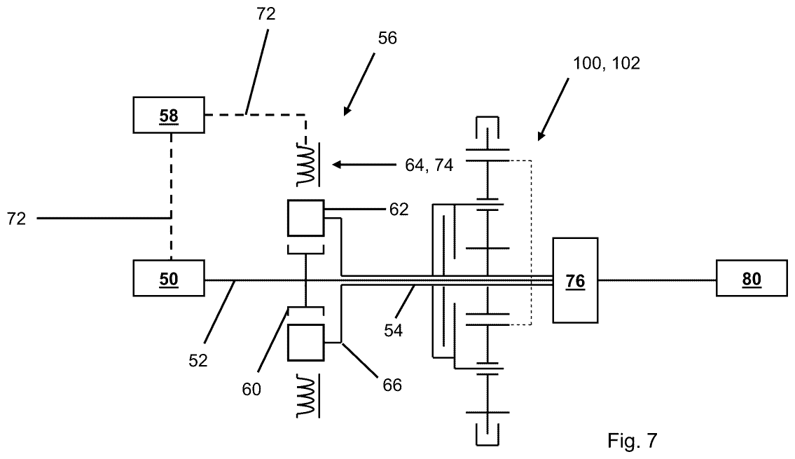

FIGS. 6 and 7 shows a schematic illustration of a fifth and a sixth example embodiment of the drivetrain 20 according to the disclosure. FIGS. 6 and 7 show schematic illustrations of a fifth and a sixth example embodiment of the drivetrain 20 according to the disclosure. The drivetrain 20 shown in FIG. 6 corresponds substantially to the drivetrains 20 shown in FIGS. 1 to 5, and the drivetrain 20 shown in FIG. 7 corresponds substantially to the drivetrains 20 shown in FIGS. 1 to 6, and therefore only details and/or points of differentiation will be discussed below. The vehicle 10 may comprise the drivetrains 20 as illustrated in FIGS. 6 and 7. The drivetrain 20 comprises a powershift reversing unit 100 for reversing the direction of travel (see FIG. 6). The powershift reversing unit 100 is positioned downstream of the magnetic-electrical epicyclic transmission stage 56 in the power flow. The powershift reversing unit 100 may however also be positioned upstream of the magnetic-electrical epicyclic transmission stage 56 in the power flow. The powershift reversing unit 100 may for example have a planetary gear set 102 (see FIG. 7).

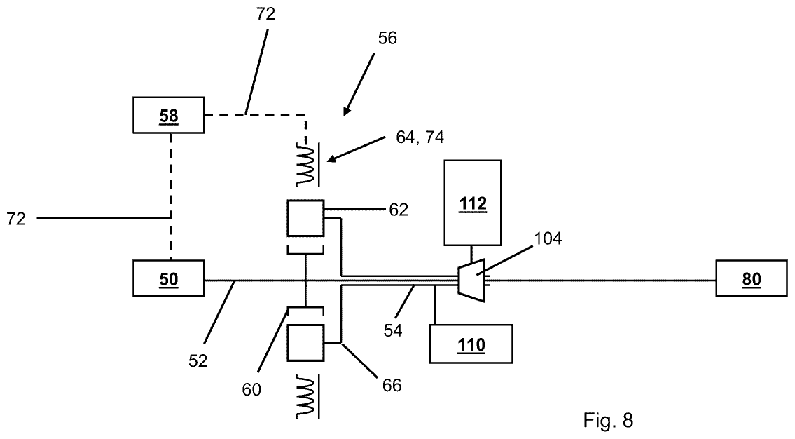

FIG. 8 shows a schematic illustration of the seventh example embodiment of the drivetrain 20 according to the disclosure. The drivetrain 20 shown in FIG. 8 corresponds substantially to the drivetrains 20 shown in FIGS. 1 and 7, and therefore only details and/or points of differentiation will be discussed below. The vehicle 10 may comprise the drivetrain 20 as illustrated in FIG. 8. A rear-axle bevel gear drive 104 is connected, for example driveably connected and/or mechanically coupled or couplable, to the output shaft 54. The rear-axle bevel gear drive 104 is in turn connected, for example driveably connected and/or mechanically coupled or couplable, to the rear-axle drive 112. The output shaft 54 may optionally also be connected to a toothing of a front-axle drive 110.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A drivetrain for a vehicle, comprising:
a first electric machine;
an input shaft connected to the first electric machine;
an output shaft;
an energy store connected to the first electric machine; and
a magnetic-electrical epicyclic transmission stage including a rotor connected to the input shaft, a stator, and an interposed modulation ring connected to the output shaft;
the energy store being connected to the stator such that electrical power can be transmitted from the energy store to the stator, which is operable such that the output shaft is rotatable counter to the direction of rotation of the input shaft, such that the drivetrain can be operated in a forward and a reverse traction mode.

2. The drivetrain of claim 1, further comprising a control unit configured to operate the drivetrain.

3. The drivetrain of claim 1, further comprising a set of power electronics in order to transmit the electrical power between the first electric machine, the energy store, and the stator of the magnetic-electrical epicyclic transmission stage.

4. The drivetrain of claim 1, wherein the output shaft is a hollow shaft and the input shaft is arranged in the output shaft such that the output shaft is coaxial with respect to the input shaft.

5. The drivetrain of claim 1, wherein the first electric machine is connected via the input shaft to a power take-off, and the modulation ring is connected via the output shaft to an axle.

6. The drivetrain of claim 1, wherein the first electric machine is connected via the input shaft to an axle, and the modulation ring is connected via the output shaft to a power take-off.

7. The drivetrain of claim 1, further comprising a first transmission unit and a second transmission unit.

8. The drivetrain of claim 7, wherein at least one of the first transmission unit and the second transmission unit includes a reverse gear.

9. The drivetrain of claim 7, wherein the first electric machine is connected via the input shaft to the second transmission unit, and the modulation ring is connected via the output shaft to the first transmission unit.

10. The drivetrain of claim 7, wherein the first electric machine is connected via the input shaft to the first transmission unit, and the modulation ring is connected via the output shaft to the second power transmission unit.

11. The drivetrain of claim 1, further comprising a powershift reversing unit for reversing the direction of travel.

12. The drivetrain of claim 11, wherein the powershift traversing unit has a planetary gear set.

13. The drivetrain of claim 1, wherein a rear-axle bevel gear drive is connected to the output shaft, and the output shaft is connected to a toothing of a front-axle drive.

14. A vehicle having a drivetrain, comprising:
a first electric machine;
an input shaft connected to the first electric machine;
an output shaft;
an energy store connected to the first electric machine; and
a magnetic-electrical epicyclic transmission stage including a rotor connected to the input shaft, a stator, and an interposed modulation ring connected to the output shaft;
the energy store being connected to the stator such that electrical power can be transmitted from the energy store to the stator, which is operable such that the output shaft is rotatable counter to the direction of rotation of the input shaft, such that the drivetrain can be operated in a forward and a reverse traction mode.

15. The vehicle of claim 14, wherein the first electric machine is connected via the input shaft to a power take-off, and the modulation ring is connected via the output shaft to an axle.

16. The vehicle of claim 14, wherein the first electric machine is connected via the input shaft to an axle, and the modulation ring is connected via the output shaft to a power take-off.

17. The vehicle of claim 14, further comprising a first transmission unit and a second transmission unit.

18. The vehicle of claim 17, wherein at least one of the first transmission unit and the second transmission unit includes a reverse gear.

19. The vehicle of claim 17, wherein the first electric machine is connected via the input shaft to the second transmission unit, and the modulation ring is connected via the output shaft to the first transmission unit.

20. The vehicle of claim 17, wherein the first electric machine is connected via the input shaft to the first transmission unit, and the modulation ring is connected via the output shaft to the second power transmission unit.
